(19) United States
(12) Patent Application Publication
(10) Pub. No.: US 2003/0226103 A1
(43) Pub. Date: Dec. 4, 2003

(54) Linking to a page

(76) Inventors: Roman Hayer, Saarbruecken (DE); Stefan Kusterer, Nussloch (DE); Bernhard Drittler, Walldorf (DE); Thomas Bach, Muehlhausen (DE); Rainer Brendle, Neckargemund (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/306,812

(22) Filed: Nov. 27, 2002

Related U.S. Application Data
(60) Provisional application No. 60/386,039, filed on Jun. 4, 2002.

(51) Int. Cl. G06F 17/00

(52) U.S. Cl. 715/501.1

(57) ABSTRACT

A method includes retrieving a page address from a repository based on a user role and an object link and linking to a page based on the page address. The method may include extracting an object ID from the link. The method may also include using a generator to determine the address based on a user role and the object ID. The method further includes recording the user role.

A method includes receiving object link information twice in response to two different invocations of a link and serving two different pages in response to the received link information based on role information associated with a user or users who invoked the link.

### CROSS-REFERENCE TO RELATED APPLICATIONS

This application claims benefit from U.S. Provisional Application No. 60/386,039, filed Jun. 4, 2002 and entitled “Intelligent Navigation,” which is incorporated by reference in its entirety.

### TECHNICAL FIELD

This disclosure relates to linking to a page.

### BACKGROUND

A hyperlink is an element of an electronic document, e.g., a web page. The hyperlink allows a user to connect to another location within the electronic document or to another electronic document. Typically, the hyperlink is activated by moving a mouse curser over the hyperlink and clicking on a mouse button. A hyperlink contains a unique resource locator (URL). The URL contains the address of the web page that the current web page is linked to. A hyperlink may appear as highlighted text, an icon, or a graphic, for example. In general, an electronic document may have several hyperlinks that connect to other electronic documents that, in turn, also have several hyperlinks.

The beginning or end of a hyperlink is marked by anchors. An “href” marks an anchor as being the start of a link to another document or a resource (e.g., an image file), or to a particular place in another document. The address of the referenced document can be specified by an absolute or partial URL:

<A HREF=“URL”>anchor</A>.

Typically, a portal acts as a gateway to the Internet, applications or communications media. A portal includes one or more portal pages. Some portal pages contain an iView. The iView is a program that retrieves data from content sources, and displays it in a portal. The iView contains specific information that comes from almost any source such as applications, the Internet, an Intranet, and electronic documents, for example.

Saving hyperlinks is called “bookmarking.” The saved link is called a “bookmark.” Bookmarks are typically sent from one user to another user or saved in an electronic document.

### SUMMARY

In one aspect, the invention is a method. The method includes retrieving a page address from a repository based on a user role and an object link and linking to a page based on the page address.

In another aspect the invention is an apparatus. The apparatus includes a memory that stores executable instructions for linking to a page and a processor. The processor executes the instructions to retrieve a page address from a repository based on a user role and an object link and link to a page based on the page address.

In still another aspect the invention is an article. The article includes a machine-readable medium that stores executable instructions for linking to a page. The instructions cause a machine to retrieve a page address from a repository based on a user role and an object link and link to a page based on the page address.

In still further aspect, the invention is a method. The method includes receiving object link information twice in response to two different invocations of a link and serving two different pages in response to the received link information based on role information associated with a user or users who invoked the link.

One or more of the aspects above include one or more of the following features. The object link can include an object type, a method type, and an object identification. The object type ca correspond to one or more applications. The method type can correspond to a single application. The object link can be accessed on a second page.

Retrieving a page address can includes retrieving the page address based on the object type and the method type. Linking to the page can include linking to the page based on the object identification.

Other features can include rendering the page. Other features can also include receiving a request to link to the page after a user has activated the object link by selecting the object link.

Various aspects of the invention can provide one or more of the following advantages. Having a central location that stores page addresses improves the accuracy and maintenance of the links. For example, without the object link repository, hyperlinks may point to other web pages that no longer exist or web pages that have different information on the page than what was originally intended. Furthermore, it is cumbersome for a developer to update every hyperlink in the pages of a site when changes are required. By having all the necessary address information centralized in the object link repository, a developer may go to one place to update page addresses. In addition, the developer does not need to place page addresses in the link.

Other advantages include using the object link repository to associate a user role with the object link in selecting an appropriate web address. For example, when two users having different user roles activate a given link, they would be taken to different web addresses tailored to their respective user roles. As a result, a developer need not specify two different page addresses when coding the page.

By having a URL dispatcher, links can be bookmarked and sent to other users. The URL Dispatcher resolves the role dependencies and renders a page based on the user role of the user executing the link.

### DESCRIPTION OF THE DRAWINGS

FIG. 1 shows a process for linking to the page.

FIG. 2 shows a linking process of FIG. 1.

FIG. 3 is a functional diagram for linking to a page.

FIG. 4 is a functional diagram showing portal and system user role redundancy.

FIG. 5 is a functional diagram of an application of an object link navigation system.

FIG. 6 shows a schema of an object link repository.

FIG. 7 shows a detailed schema of the object link repository of FIG. 6.

FIG. 8 is a functional diagram for executing a bookmarked link.

### DESCRIPTION

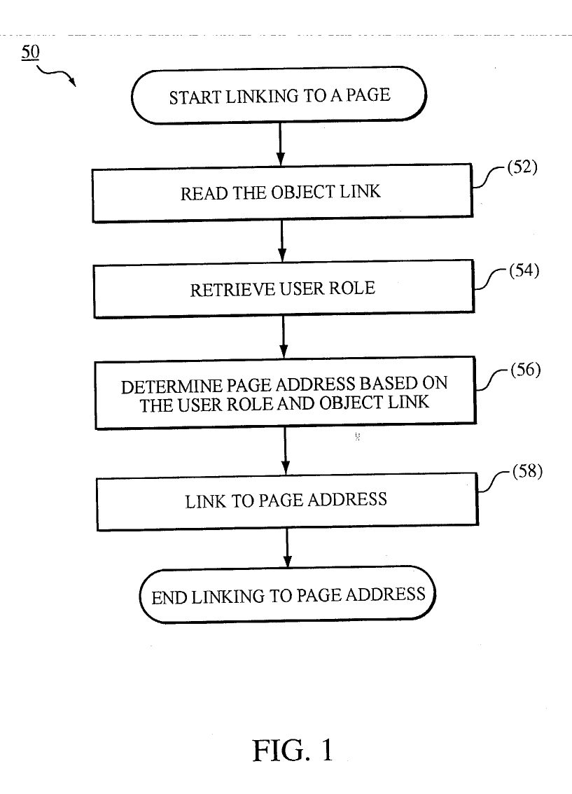

Referring to FIG. 1, when a user activates an object link, a process 50 navigates (switches) the user from a current web page to the same or a different web page based on a user role (profile) and the object link. The target web page can be in a same or different application. The object link includes object link parameters but, unlike regular hyperlinks, the object link does not include page address information (e.g., a URL) nor does it contain information about the user role.

As will be shown below, an object link repository stores, in a table, page address information associated with combinations of object link parameters and user roles. The user role and object link parameters can together be used to determine the appropriate web page address. Even though the object links are user dependent, the links can be bookmarked and sent to other users, who have other user roles.

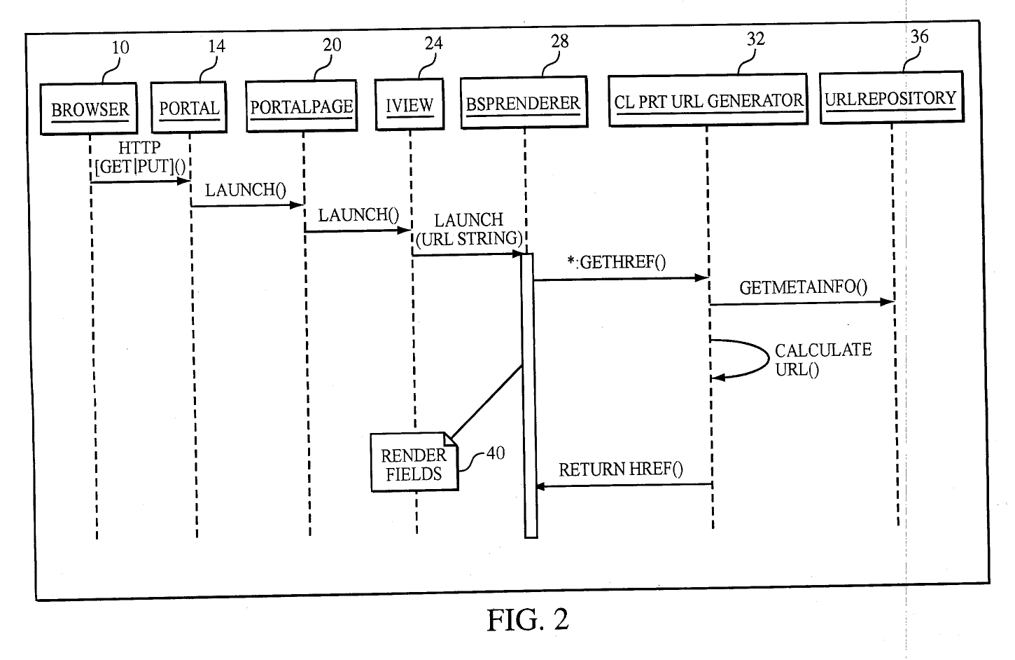

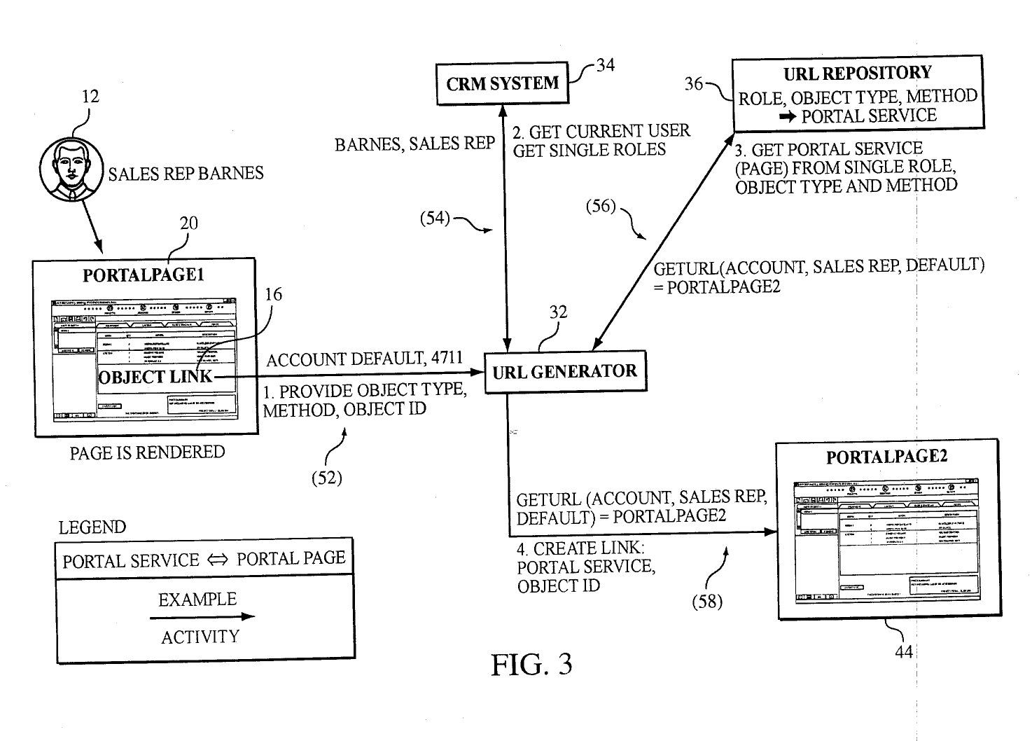

For example, referring to FIGS. 2 and 3, after a user 12 activates an object link 16, a browser 10 sends a request to an application, e.g., a Business Server Page (BSP) application 28. The request is sent through a portal 14 via a portal page 20 within the portal and through an iView 24 on the portal page.

A portal can be, for example, a Java application and the request is in the form of a JavaScript. The JavaScript portion is responsible for the direct execution of a link. Each link includes an anchor tag having an href and an onclick code. The anchor tag is formatted as (<a href=“ . . . ” onclick=“ . . . ”>Description of target</a>). The onclick code provides instructions to the portal environment which portal page to display, and to adapt any top-level navigation entries to reflect the change. When the user clicks on the link the onclick code is executed first. The href attribute is not executed during navigation; however, as will be explained below, the href attribute is used for bookmarking.

During the navigation, the application invokes a page renderer 28 that builds a HyperText Markup Language (HTML) Page. In response to the onclick code, a page renderer 28 requests a corresponding URL. This request is forwarded to a URL Generator 32. URL Generator 32 retrieves a URL from a URL repository 36 based on a user role (for the user who was the source of the navigation request) retrieved from a system 34, e.g., a Customer Relationship Management (CRM) system, and the object link. URL generator 32 executes the URL and a corresponding page 44 is rendered in render fields 40 of iView 24, based on the page that is invoked by the executed URL.

Referring back to FIG. 1 for additional detail, process 50 reads (52) the object link and retrieves the object link's parameters. The object link includes three parameters: an ObjectID, an Object Type, and a Method. The ObjectID is an identifier that uniquely identifies the object link. For example, the ObjectID can be a number, e.g., 4711. The Object Type describes the type of object link. For example, the Object Type can be a “book” link, that links to a page of a book.

The Method describes alternate uses for the Object Type. Thus, a web page designer can select different applications for a given Object Type and user role. For example, if a book shop publisher has generated a page with links to books and the Object Type is a “book,” then one Method could be a “Detailed Information” Method which provides detailed information about the book. Another Method could be a “Buy” Method enabling a user to purchase the book. In this example, a web designer can provide two object links having the same Object Type depending on which action depending on which action the designer wishes to be invoked:

1. More(Objecttype:=Book, ObjectID:=4711, Method:=Detailed Information)

2. More(Objecttype:=Book, ObjectID:=4711, Method:=Buy)

Every Method parameter implies a default so that a web designer does not need to designate the Method for each hyperlink.

For example, referring back to FIG. 3, URL generator 32 may receive the Object Type, the ObjectID and the Method data from object link 16. For example, object link 16 may include an Object Type corresponding to an “Account Page,” a Method set to “Default,” and an ObjectID of 4711.

Process 50 retrieves (54) the user roles (FIG. 1). The user roles are stored in a system 34 with which the user has an active session. In connection with the session, system 34 recognizes the user's identification (ID) and passwords and assigns an appropriate user role. For example, if a salesperson logs-in into system 34 to a remote location by giving a user ID and a password. System 34 may recognize this user as having a “sales representative” user role and provides that role to the generator 32 which then is able to display pages tailored for a sales representative.

As indicated above, navigation to specific web pages from object links is user role dependent. If, for example, a regional sales manager navigates to an account maintenance page, the sales manager will see a different web page than the one that a “sales representative” would be shown if the “sale representative” accessed the same object link.

Linking can occur even when two different user roles are used by one user. In this case, the object link within the application can link to different locations based on the user's context. For example, in one context, the user is only assigned to a “sales representative” user role so that navigation leads to the Accounts page for a sales representative. In another context, the user is only assigned to the “sales manager” user role so that navigation points to the Accounts page tailored for a sales manager.

In a further context that combines both previous contexts, the user is assigned to both a “sale representative” and a “sales manager” user roles. System Administrators can customize which user role is used by setting priorities as to which target hosting the Account page is appropriate for a particular situation. For example, the first time user 12 accesses the Account page, a “sale representative” tailored Account page could be rendered, and the second time the user accesses the Account page, a “sales manager” tailored Account page could be rendered.

Process 50 determines (56) the appropriate page address based on the user role and the object link (FIG. 1). URL generator 32 retrieves the appropriate web address from the URL repository 36. URL repository 36 includes tables that have rows that include the object type, the Method, and the user role with their corresponding URL addresses.

For example, in FIG. 3, URL generator 32 determines the URL using the “Account” as the object Type, “Sales Representative” as the user role and “Default” as the method and finds the corresponding web address that includes all these elements.

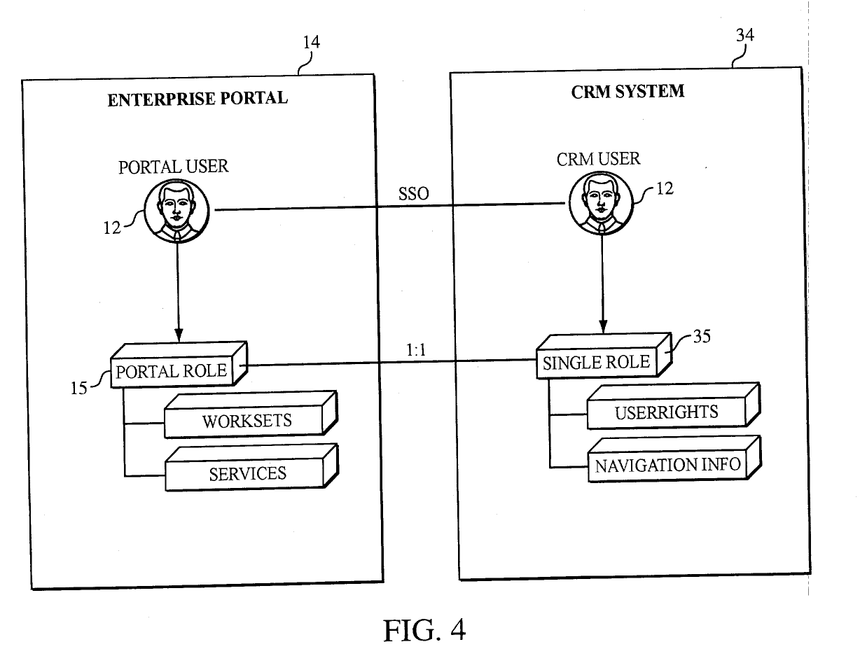

Referring to FIG. 4, in some examples, during navigation in system 34, conflicts may arise in acquiring the user roles that the user is assigned to in portal 14 versus the user roles in system 34. To resolve this conflict, the user role information is duplicated between portal 14 and system 34. FIG. 4 shows the redundancy between a portal user role 15 and a CRM single user role 35.

Process 50 links (58) to a web page corresponding to the page address (FIG. 1). URL generator 32 uses the URL and the ObjectID to render the appropriate web page 44.

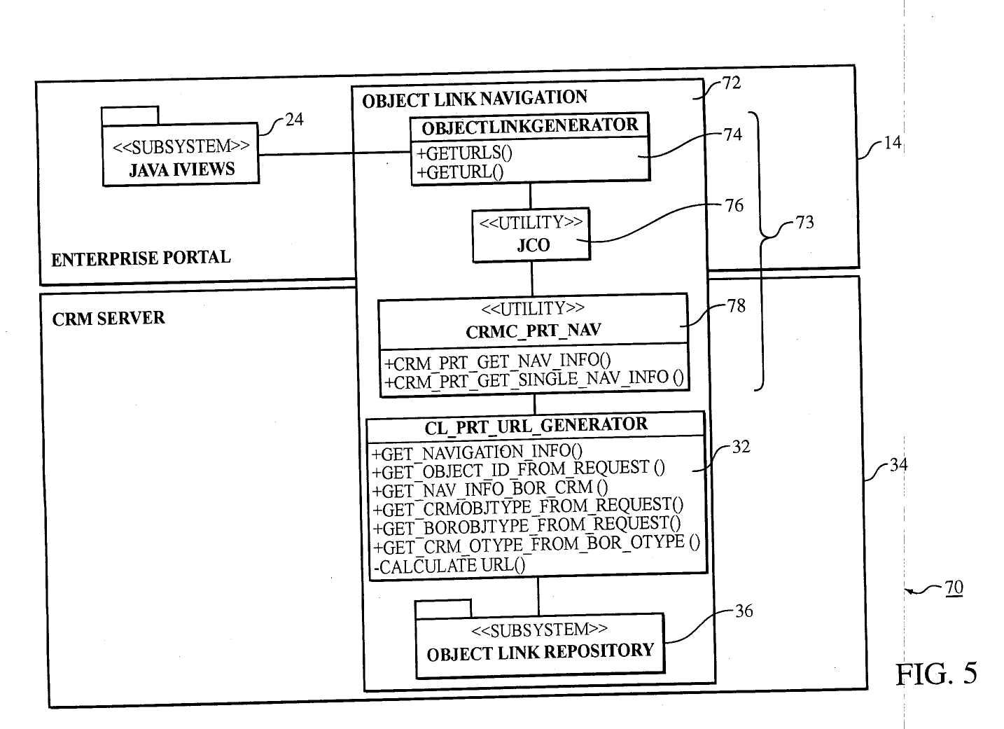

Referring to FIG. 5, in one implementation, a portal-system architecture 70, using a process 50, includes an object link navigation module 72 that is used to support object link navigation from either portal 14 or system 34 when an object link is activated.

Module 72 includes a wrapper 73 (e.g., a Java Wrapper) for accessing URL generator 32 from outside system 34. Wrapper 73 includes an Object Link Generator 74, an integrator 76, and a Portal Navigator Utility 78.

Object Link Generator 74 sends requests for URL addresses from iView 24 to integrator 76, e.g., a Java connector (JCO). The Object Link Generator 74 uses one of two functions to calculate object links. One function is used for a single object link (getUrl ( )) and the other function is used for a list of object links (getUrls ( )) . The function getUrls ( ) is for the fast retrieving of object links in grids. Thereby, a set of URLs is calculated in one request instead of invoking a URL multiple times.

For example, a Java representation of the getUrl( )function is:

public static String getUrl(IPortalComponentRequest request, String borObjectType, String crmObjectType, String objectId, String method, String logicalSystem, UrlParameterRemoteSet params),

and a Java representation of the getUrls( ) function is:

public static JCO.Table getUrls(IPortalComponentRequest request, JCO.Table linkInfos, UrlParameterSetKeyMap paramsTable).

Integrator 76 integrates the request and relays the URL requests through a Portal Navigator Utility 78 for further processing by URL generator 32. Portal Navigator Utility 78 includes two functions. The first function (CRM_PRT_NAV_INFO( )) retrieves navigational information from the URL generator 32 for multiple objects. The second function (CRM_PRT_SINGLE_NAV_INFO( )) retrieves navigational for a single object link.

URL generator 32 obtains an objectID from the request. The objectID is transported via the URL when the application was started via object link. In this case, the transported objectID is retrieved by using a ObjectID Request function (GET_OBJECT_ID_FROM_REQUEST).

The following is an example of the ObjectID Request function (GET_OBJECT_ID_FROM_REQUEST):

CALL FUNCTION

cl_prt_url_generator=>get_object_id_from_request

EXPORTING

| | |
|---|---|
| ir_request | = request |

RECEIVING

| | |
|---|---|
| re_object_id | = lv_object_id. |

IF lv_object_id IS NOT INITIAL.

APPEND lv_object_id TO gt_object_key.

ENDIF.

At runtime, the applications call a Navigation Information function (GET_NAVIGATION_INFO) within URL Generator 32 to retrieve the URL address information to navigate to. An example of the Navigation Information function for retrieving URL information is:

| FUNCTION get_link. | | |
|---|---|---|
| * | | |
| * | Importing: | |
| * | IS_FGT | Type CRMC_FIELDGRP |
| * | IV_COLUMN_KEY | Type STRING |
| * | Exporting: | |
| * | EV_URL | Type STRING |
| * | EV_JAVASCRIPT | Type STRING |
| * | | |

| | |
|---|---|
| DATA: lv_obj_type | TYPE char20. |
| DATA: lv_bor_type | TYPE char10. |
| DATA: lv_obj_id | TYPE char70. |

FIELD-SYMBOLS: <gt_obj> TYPE crm_bsp_link_resultlist.
READ TABLE gt_obj WITH KEY fieldname = iv_column_key

ASSIGNING <gt_obj>.

IF sy−subrc = 0.

| | |
|---|---|
| lv_obj_type | = <gt_obj>−objecttype. |
| lv_obj_id | = <gt_obj>−objectid. |

| | IF is_fgt−url_fnotisbor IS NOT INITIAL. |
|---|---|
| | lv_bor_type = <gt_obj>−objecttype. |
| * | Get CRM type from BOR type |
| | CALL METHOD |

cl_prt_url_generator=>get_crm_otype_from_bor_otype

EXPORTING

bor_object_type = lv_bor_type

RECEIVING

crm_object_type = lv_obj_type.

ENDIF.

*Generate URL string

TRY.

CALL FUNCTION

cl_prt_url_generator=>get_navigation_info

EXPORTING

| | |
|---|---|
| im_object_type | = iv_obj_type |
| im_method | = is_fgt−url_method |
| im_object_id | = lv_obj_id |

IMPORTING

| | |
|---|---|
| ex_url | = ev_url |
| ex_javascript | = ev_javascript. |

CATCH cx_prt_urlgen_inv_objtypemthd.

ENDTRY.

```
          ENDIF.
        ENDFUNCTION.
```

Another function, called a BOR Navigation Info function (GET_NAV_INFO_BOR_CRM( )) for retrieving URL information is used for Business Object Repository (BOR) links.

Two other functions used in the URL generator 32 are used to retrieve the object type from the object link from the URL request. One function is used for retrieving CRM Object types (GET_CRMOBJTYPE_FROM_REQUEST) and another is used for retrieving BOR Object types (GET_BOROBJTYPE_FROM_REQUEST).

In some embodiments, an application does not recognize the Business Object Repository (BOR) type of the object. In this case, an Object Type Conversion function (GET_CRM_OTYPE_FROM_BOR_OTYPE( )) is used to convert the BOR type to an object type.

After URL generator 32 retrieves the object type and ObjectID, the URL generator calculates the URL based on object link repository 36 by user role. URL generator 32 uses a function (CalculateURL ( )) to calculate and return a URL.

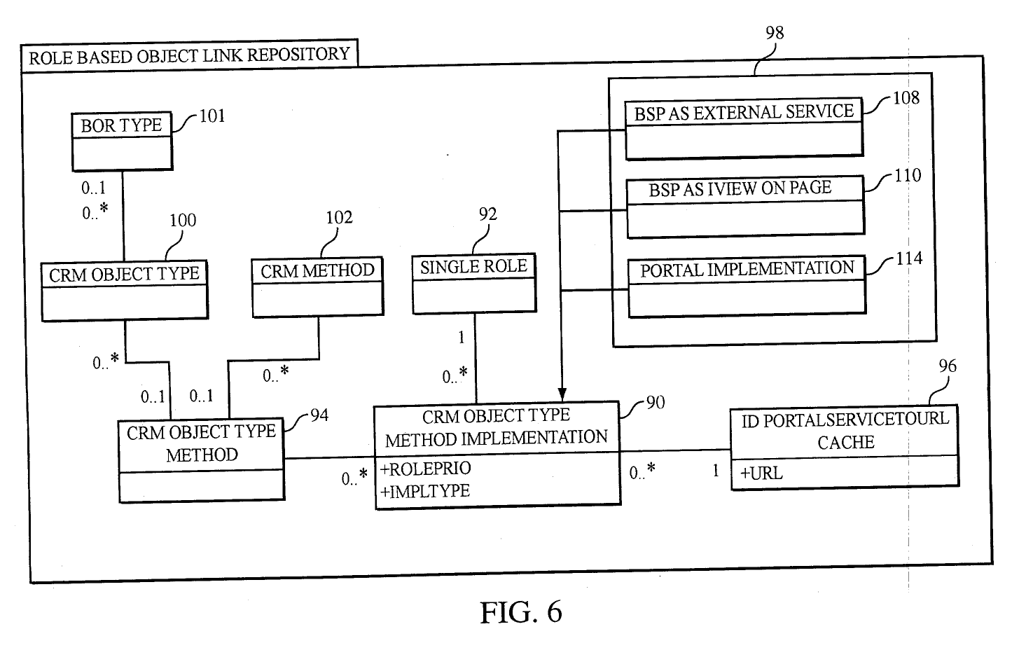

FIG. 6 is an example of an object link repository containing data structures. Each of the structures within the object link repository is maintained by an administrator. An Object-Type-Method-Implementation table 90 includes dependencies from a Role table 92, an Object-Type-Method table 94, an ID-PortalService-To-URL-Cache table 96 and a Port-System table 98.

Role table 92 contains the user role information. Object-Type-Method table includes dependencies to other tables including an Object Type table 100 (receiving input from a BOR Type table 101), and a Method table 102. ID-PortalService-To-URL-Cache table 96 maintains the URL addresses.

Port-System table 98 includes target information of the URL navigation. For example, an object link executed in system 34 from an External Service (e.g., the Internet) would have the target information in an External Service table 108. An object link executed in system 34 from an iView would have target information in an iView table 110. Any other portal target information would be stored in a Portal Implementation table 114. The target information are similar to drivers in that only the name is stored.

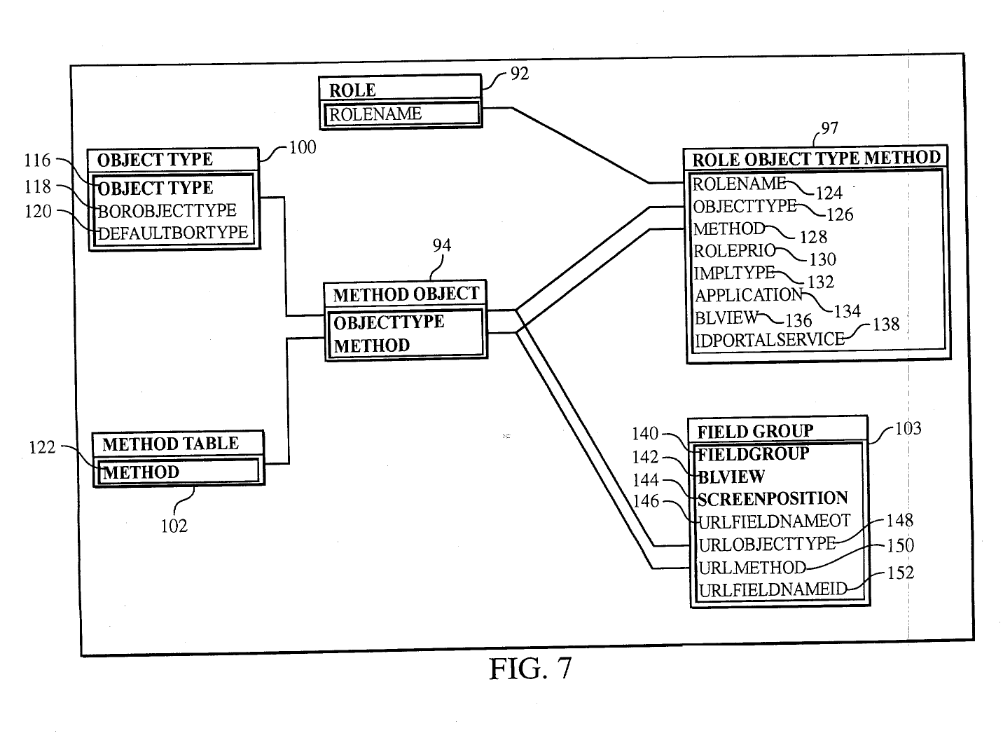

FIG. 7 is a detailed database representation of the object link repository of FIG. 6. Object Table 100 includes an object types field 116 for storing object types, a BOR Object Type Field 118 for storing BOR object Types, and a default BOR Object Type field 120 for storing default BOR object Types.

Method table 102 includes a methods field 122. Object table 100 and Method table 102 are linked to the Method-Object Table 94. The methods within Method-Object Table 94 are assigned to portal pages in portal roles and define the available methods for a given object type.

During implementation, a new role is formed based on the assignment of object type methods to portal services. To provide an application view as the destination for an object link, an implementation meta information object is formed. The entries are maintained in a Role-Object-Type-Method table 97 that includes Object-Types-Method-Implementation Table 90 and Port-System table 98. Role-Object-Type-Method table 97 is maintained by portal administrators and is used by the URL generation process to create URLs to portal pages hosting the appropriate application.

The Field descriptions include a role name 124, which contains a reference to the single role that is replicated from the Portal. The role name is redundant to the role name stored in role table 92. Other field descriptions include an object type 126, a method 128, which contains a reference to the object type method; and a role priority 130. Role priority 130 contains a number indicating the priority of roles concerning object type implementations, e.g., a low number equates to a high priority.

The Field descriptions also include an implementation type 132, which contains a flag indicating the type of implementation. Other field descriptions include an application field 134, a View field 136, which is virtually a reference to the blueprint table that acts as the implementation code (like a function pointer into main memory of a programming language). The Field descriptions further includes an ID Portal service 138, which contains a Portal Content Directory (PCD) Locator (ID) of the portal service that hosts the BSP application view and is used to calculate the URL.

A Field group table 103 includes a Field Group Field 140, a view field 142, a screen position field 144 a URL Fieldname Object type 146, tied to a URL object type field 148, a URL method field 50 and a URL field name ID 152.

Using field group table 103, a developer can generate different objects links including a standard object link, a special object link, and a mixed list link. A standard object link is treated does not contain a ‘method’ type. A special object link specifies a special method. A mixed list link includes a list in the page that shows different object types.

To generate an object link, the developer chooses an object type in a URL Object Type field 146; chooses a “DEFAULT” method in a URL Method field 150; and puts a fieldname of a field containing the object ID into Field Name ID field 152.

To generate a special object link, the developer chooses an object type in the URL Object Type field 146, chooses an appropriate method in the URL Method field 150 and puts a fieldname of field containing the object ID into Field Name ID field 152.

To generate mixed list links, the developer leaves an object type field 148 empty and puts the fieldname of the column containing the object type in Field Name Object Type field 146. In addition, the developer, chooses a method, “DEFAULT” (or other) in URL Method field 150 and puts the fieldname of a field containing the object ID into the Field Name ID field 152. If a developer chooses to provide BOR types instead of CRM object types, the developer sets a BOR flag (URL_FNOTISBORFLG).

Dispatcher

When an address is bookmarked, no user role information is saved. Instead, the link includes the object type, the method, and the object id. Arbitrary parameters that were sent with the address are unchanged and routed to the target page. If the user forwards the link to another user, who has a different user role, the latter user may have problems viewing the page. A navigation dispatcher 33 is used to resolve the role dependencies.

The dispatcher is a portal component that is accessed via a fixed URL. At run-time, generator 32 requests (via a Java wrapper) the address according to the current user role. The URL Dispatcher redirects the browser to the corresponding page.

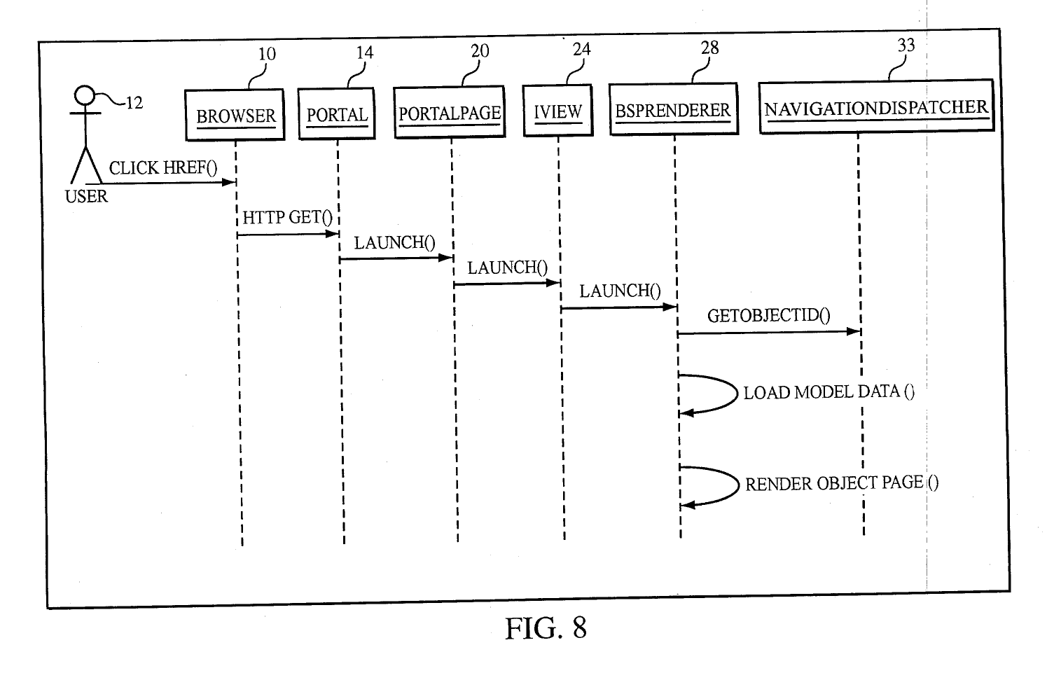

Referring to FIG. 8, when a bookmark within browser 10 is accessed, the href attribute within the anchor tag is used. The request is sent through a portal 14, portal page 20, iView 24, and renderer 28 to navigation dispatcher 33. Navigation dispatcher loads the model data and renders the object page.

For bookmarking with dispatcher 33, the following syntax is used:

| | |
|---|---|
| <protocol> | [http or https] |
| :// | |
| <portalserver> | [name of portal server] |
| : | |
| <port> | [port] |
| / | |
| <application> | [by now, always “SAPPortal”] |
| /?NavigationTarget= | |
| <dispatcherUrl> | [by now, “”] |
| &CRM_OBJECT_ID= | |
| <oid> | [object id for dispatcher] |
| &CRM_OBJECT_TYPE= | |
| <ot> | [CRM object type for dispatcher] |
| &CRM_METHOD= | |
| <mtd> | [method for dispatcher] |
| &˜logical_system= | |
| <logSys> | [logical system for DNR] |
| &˜object_type= | |
| <objType> | [BOR type for DNR] |
| &˜object_key= | |
| <objKey> | [object key for DNR (=object id)] |
| [&<add_param_name_1>= | |
| <add_param_value_1> | [optionally, additional parameters |
| ... | along with their respective values |
| &<add_param_name_i>= | can be sent.] |
| <add_param_value_i>] | |

Process 50 is not limited to the specific embodiments described herein. For example, the blocks of FIG. 1 may be re-ordered, as necessary, to achieve the results set forth above.

Other embodiments are within the claims.

What is claimed is:

1. A method comprising:
retrieving a page address from a repository based on a user role and an object link; and
linking to a page based on the page address.

2. The method of claim 1 wherein the object link comprises an object type.

3. The method of claim 1 wherein the object link comprises a method type.

4. The method of claim 1 wherein the object link comprises an object identification.

5. The method of claim 2 wherein retrieving a page address comprises retrieving the page address based on the object type.

6. The method of claim 3 wherein retrieving a page address comprises retrieving the page address based on the method type.

7. The method of claim 4 wherein linking to the page comprises linking to the page based on the object identification.

8. The method of claim 1 wherein the object type corresponds to one or more applications.

9. The method of claim 8 wherein the method type corresponds to a single application.

10. The method of claim 1 further comprising:
rendering the page.

11. The method of claim 1 further comprising,
receiving a request to link to the page after a user has activated the object link by selecting the object.

12. The method of claim 1 wherein the object link is accessed on a second page.

13. A method comprising:
receiving object link information twice in response to two different invocations of a link, and
serving two different pages in response to the received link information based on role information associated with a user or users who invoked the link.

14. An apparatus comprising:
a memory that stores executable instructions for linking to a page; and
a processor that executes the instructions to:
retrieve a page address from a repository based on a user role and an object link; and
link to a page based on the page address.

15. The apparatus of claim 14 wherein the object link comprises an object type.

16. The apparatus of claim 14 wherein the object link comprises a method type.

17. The apparatus of claim 14 wherein the object link comprises an object identification.

18. The apparatus of claim 15 wherein the instructions to retrieve a page address comprises retrieving the page address based on the object type.

19. The apparatus of claim 16 wherein the instructions to retrieve a page address comprises retrieving the page address based on the method type.

20. The apparatus of claim 17 wherein the instructions to link to the page comprises linking to the page based on the object identification.

21. The apparatus of claim 14 wherein the object type corresponds to one or more applications.

22. The apparatus of claim 21 wherein the method type corresponds to a single application.

23. The apparatus of claim 14 further comprising the instructions to:
render the page.

24. The apparatus of claim 14 further comprising the instructions to:
receive a request to link to the page after a user has activated the object link by selecting the object link.

25. The apparatus of claim 14 wherein the object link is accessed on a second page.

26. An apparatus comprising:
a memory that stores executable instructions for linking to a page; and
a processor that executes the instructions to:
receive object link information twice in response to two different invocations of a link, and
serve two different pages in response to the received link information based on role information associated with a user or users who invoked the link.

27. An article comprising:
a machine-readable medium that stores executable instructions for linking to a page, the instructions causing a machine to:
retrieve a page address from a repository based on a user role and an object link; and
link to a page based on the page address.

28. The method of claim 27 wherein the object link comprises an object type.

29. The method of claim 27 wherein the object link comprises a method type.

30. The method of claim 27 wherein the object link comprises an object identification.

31. The method of claim 28 wherein the instructions causing a machine to retrieve a page address comprises instructions causing a machine to retrieve the page address based on the object type.

32. The method of claim 29 wherein the instructions causing a machine to retrieve a page address comprises instructions causing a machine to retrieve the page address based on the method type.

33. The method of claim 30 wherein the instructions causing a machine to link to the page comprises instructions causing a machine to linking to the page based on the object identification.

34. The method of claim 27 wherein the object type corresponds to one or more applications.

35. The method of claim 34 wherein the method type corresponds to a single application.

36. The method of claim 27 further comprising instructions causing a machine to:
render the page.

37. The method of claim 27 further comprising instructions causing a machine to:
receive a request to link to the page after a user has activated the object link by selecting the object link.

38. The method of claim 27 wherein the object link is accessed on a second page.

39. A method comprising:
receiving object link information twice in response to two different invocations of a link, and
serving two different pages in response to the received link information based on role information associated with a user or users who invoked the link.
